(19) United States
(12) Patent Application Publication
(10) Pub. No.: US 2011/0276907 A1
(43) Pub. Date: Nov. 10, 2011

(54) MONITORING SYSTEM AND METHOD FOR MONITORING THE STATE OF A TECHNICAL INSTALLATION

(75) Inventors: Alexander Burkhardt, Aichtal (DE); Frank Hackländer, Stuttgart (DE); Rainer Ordenewitz, Fellbach-Oeffingen (DE)

(73) Assignee: Siemens Aktiengesellschaft, Munchen (DE)

(21) Appl. No.: 12/939,707

(22) Filed: Nov. 4, 2010

(30) Foreign Application Priority Data
Nov. 5, 2009 (EP) EP09175097

(51) Int. Cl. G06F 3/01

(52) U.S. Cl. 715/760

(57) ABSTRACT

A method for monitoring a state of a technical installation includes the steps of transmitting, by using a web browser, via the Internet to web server software a user request to display a web page with first data relating to the technical installation, wherein the web server software has access to the first data, transmitting with the web server software the first data to first server software, transforming with the first server software the first data into first display data configured to be interpreted by the web server software, transmitting the first display data to the web server software for construction of the web page with the first data, and transmitting the constructed web page to the web browser for displaying the web page. A corresponding monitoring system using the method is also disclosed. Integration of a measuring device in the monitoring system is hereby facilitated.

### CROSS-REFERENCES TO RELATED APPLICATIONS

This application claims the priority of European Patent Application, Serial No. EP09175097, filed Nov. 5, 2009, pursuant to 35 U.S.C. 119(a)-(d), the content of which is incorporated herein by reference in its entirety as if fully set forth herein.

### BACKGROUND OF THE INVENTION

The present invention relates to a method for monitoring the state of a technical installation. The invention also relates to a corresponding monitoring system.

The following discussion of related art is provided to assist the reader in understanding the advantages of the invention, and is not to be construed as an admission that this related art is prior art to this invention.

Monitoring systems for monitoring the state of a technical installation generally have a plurality of measuring devices from a wide variety of manufacturers with a wide variety of basic technologies. Such monitoring systems are also technically referred to as so-called condition monitoring systems. In this case, the measuring devices provide the data which are needed to monitor the state of the technical installation and may be in the form of temperatures, speeds and oscillations of components of the installation, for example. In the case of a monitoring system for monitoring the state of the technical installation, it is therefore important to provide the user intending to monitor the state of the technical installation with standardized integrated operating guidance and an operating view of all the measuring devices and the data provided by the latter. A fundamental problem in this case is a standardized representation and handling of measurement results provided by measuring devices from a wide variety of manufacturers.

Homogeneous operating guidance and display of the heterogeneous system landscape which is normally present have hitherto been enabled in monitoring systems for monitoring the state of a technical installation only on a project-specific basis by creating integration software which is specialized for the respective installation.

It would therefore be desirable and advantageous to address this problem and to obviate other prior art shortcomings by providing a monitoring system and a method for monitoring the state of a technical installation which facilitates easy integration of a measuring device in the monitoring system

### SUMMARY OF THE INVENTION

According to one aspect of the present invention, a method for monitoring a state of a technical installation includes the steps of transmitting, by using a web browser, via the Internet to web server software a user request to display a web page with first data relating to the technical installation, wherein the web server software has access to the first data, transmitting with the web server software the first data to first server software, transforming with the first server software the first data into first display data configured to be interpreted by the web server software, transmitting the first display data to the web server software for construction of the web page with the first data, and transmitting the constructed web page to the web browser for displaying the web page.

According to another aspect of the invention, a monitoring system for monitoring a state of a technical installation includes a computation device storing first data relating to the technical installation, web server software running on the computation device and causing the computation device to transmit, by using a web browser, via the Internet to web server software a user request to display a web page with the first data relating to the technical installation, wherein the web server software has access to the first data, to transmit with the web server software the first data to first server software, to transform with the first server software the first data into first display data configured to be interpreted by the web server software, to transmit the first display data to the web server software for construction of the web page with the first data, and to transmit the constructed web page to the web browser for displaying the web page.

The invention also enables standardized display of data in a monitoring system for monitoring the state of a technical installation.

It proves to be advantageous if a user uses a web browser to transmit a request to display a web page, on which first and second data relating to the installation are intended to be displayed, to web server software via the Internet, the web server software having access to the first and second data, the web server software transmitting the first data to first server software, the first server software transforming the first data into first display data which can be interpreted by the web server software and transmitting the first display data to the web server software, the web server software transmitting the second data to second server software, the second server software transforming the second data into second display data which can be interpreted by the web server software and transmitting the second display data to the web server software, the web server software using the first and second display data to construct the web page and transmitting the latter to the web browser for displaying the web page. This makes it possible to easily integrate the data in order to achieve an overall display of the data, which are generated by measuring devices from different manufacturers, on a web page.

It also proves to be advantageous if the data are transmitted to the server software and the display data are transmitted from the server software to the web server software via the Internet. This makes it possible to run the first server software and, if present, the second server software on computation units which are locally remote and far away from the computation device, with the result that the computation device, for example, can be located at a service provider's premises and the respective server software can run on a computation unit which may be located at the premises belonging to the manufacturer of the measuring device which generates the respective data.

It also proves to be advantageous if the data are transmitted from the web server software to the server software in the form of an XML code since an XML code (Extensible Markup Language) is a code which is widespread in Internet applications.

It also proves to be advantageous if the display data are in the form of HTML code since an HTML code (Hypertext Markup Language) is a code which is widespread in Internet applications.

It also proves to be advantageous if the web server software uses the display data to construct the web page and transmits the web page in the form of HTML code to the web browser for displaying the web page since an HTML code (Hypertext Markup Language) is a code which is widespread in Internet applications.

It also proves to be advantageous if the technical installation has an individual measuring device or a plurality of measuring devices which generate the data, the data being transmitted from the installation, via the Internet, to a computation device on which the web server software runs and being stored in the computation device. In this case, the installation is preferably connected to the Internet via a client, that is to say a computer on which client software runs. The data can be transmitted from the installation, via the Internet, to the computation device in a particularly simple manner using the client.

It also proves to be advantageous if the first server software runs on a first computation unit, the first computation unit being connected to the computation device via the Internet. This makes it possible to run the first server software on a computation unit which is locally far away from the computation device, with the result that the computation device, for example, can be located at a service provider's premises and the respective server software can run on a computation unit which may be located at the premises belonging to the manufacturer of the measuring device which generates the data.

It also proves to be advantageous if the first server software runs on the computation device since the monitoring system can then be implemented with a minimum outlay on hardware.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a monitoring system according to the present invention in the form of a block illustration, and

FIG. 2 shows a flowchart of the method according to the present invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

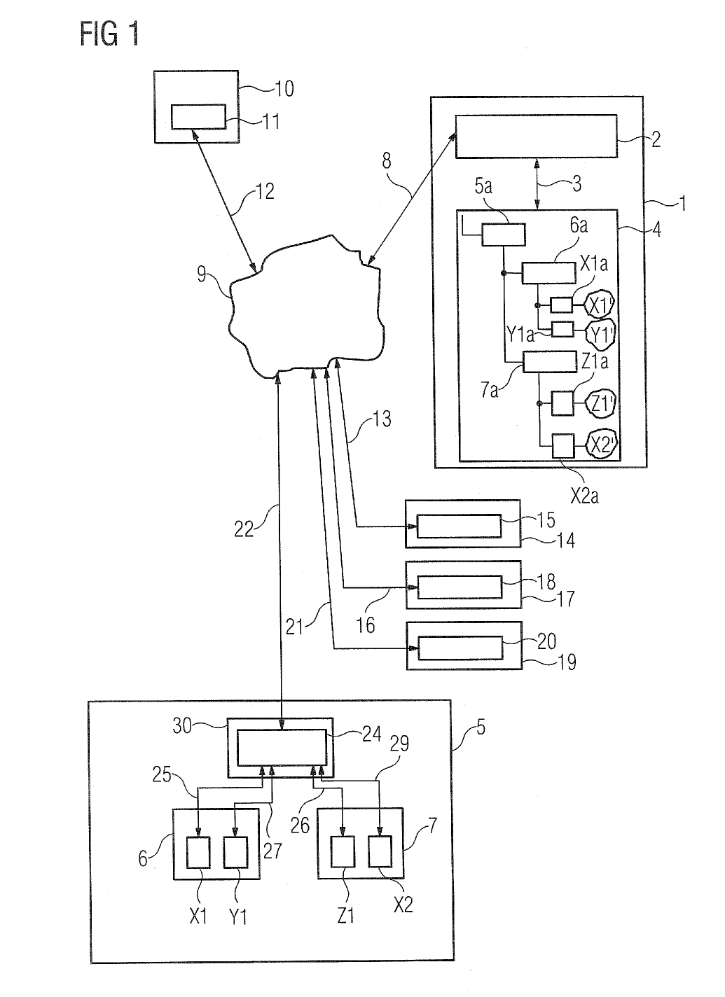

Turning now to the drawing, and in particular to FIG. 1, there is shown a schematic block illustration of a monitoring system according to the invention for monitoring the state of a technical installation 5, such a monitoring system also being technically referred to as a condition monitoring system.

Within the scope of the exemplary embodiment, the technical installation 5 is in the form of a wind turbine in this case, but the technical installation 5 may also include a plurality of wind turbines. However, it goes without saying that the technical installation 5 may also include technical installations from very different technical fields, for example an individual cement mill or a plurality of cement mills.

Within the scope of the exemplary embodiment, the technical installation 5 has a first subsystem 6 and a second subsystem 7. Within the scope of the exemplary embodiment, the first subsystem 6 is in the form of a transmission which adjusts the speed of the wind turbine to the speed required for the generator of the wind turbine, whereas the second subsystem 7 is in the form of the generator within the scope of the exemplary embodiment. In order to monitor its state, the first subsystem 6 has a measuring device X1 provided by a manufacturer X and a measuring device Y1 provided by a manufacturer Y. In order to monitor its state, the subsystem 7 has a measuring device Z1 provided by a manufacturer Z and a measuring device X2 provided by the manufacturer X. In this case, the measuring device X1 generates first data X1′ which are in the form of speed values for the wind-turbine-side part of the transmission within the scope of the exemplary embodiment. The measuring system Y1 generates second data Y1′ which are in the form of oscillation values for the subsystem 6 within the scope of the exemplary embodiment. The measuring system Z1 generates third data Z1′ which are in the form of power values for the generator within the scope of the exemplary embodiment, and the measuring device X2 generates fourth data X2 which are in the form of temperature values for the generator within the scope of the exemplary embodiment. The measuring systems transmit the data generated by them, via connections 25, 26, 27 and 29, to a computer 30 on which client software 24 runs, which software connects the computer 30 to the Internet 9 in order to transmit data. The computer 30 is thus in the form of a so-called client. The computer 30 is connected to the Internet 9 in order to transmit the data, which is illustrated by an arrow 22.

The monitoring system also has a computation device 1 which, in the simplest case, can consist, in terms of hardware, of an individual computer. In this case, the computation device 1 may have only one central processor in the simplest case or else may be in the form of a multiprocessor system. However, the computation device 1 may furthermore also consist of a plurality of individual computers, for example, which are networked to one another via a LAN connection, for example.

Web server software 2 runs on the computation device 1, that is to say the computation device 1 executes the web server software 2. Together with the web server software 2 running on the computation device 1, the computation device 1 constitutes a so-called web server which, in particular, can receive data from clients and can transmit data to clients and, in particular, can construct a web page and can transmit the latter to a web browser for display. In order to store the data transmitted from the measuring devices in the technical installation 5 to the web server software 2, the computation device 1 also preferably has a database 4 which is implemented, within the scope of the exemplary embodiment, using database software running on the computation device 1. The web server software 2 can transmit data to the database 4 and can receive data from the database 4, which is illustrated in FIG. 1 by an arrow 3. The web server software 2 thus has access to the data stored in the database 4. However, it is noted at this point that the data need not necessarily be stored inside a database in the computation device 1 either but rather may be stored quite generally anywhere in the computation device 1 and the web server software 2 has access to the data.

The first data X1′, the second data Y1′, the third data Z1′ and the fourth data X2′ are stored in the database 4. Within the scope of one advantageous embodiment of the invention, the database 4 contains a graphical image of the technical installation 5 in the form of a tree structure, as illustrated in FIG. 1. In this case, the installation 5 is illustrated in the form of the symbol 5a. The subsystem 6 is illustrated in the form of the symbol 6a and the subsystem 7 is illustrated in the form of the symbol 7a. The measuring device X1 is illustrated in the form of the symbol X1a, the measuring device Y1 is illustrated in the form of the symbol Y1a, the measuring device Z1 is illustrated in the form of the symbol Z1a and the measuring device X2 is illustrated in the form of the symbol X2a. The respective first data X1′, the second data Y1′, the third data Z1′ and the fourth data X2′ are then associated with the corresponding symbols X1a, Y1a, Z1a and X2a for the measuring devices. In this case, the first, second, third and fourth data are stored, for example, in the form of a so-called software binary code, that is to say in the form of a rudimentary sequence of zeros and ones, for example. The contents of the data, that is to say the contents of the first, second, third and fourth data within the scope of the exemplary embodiment, cannot be interpreted by the web server software 2, that is to say the web server software 2 does not know, for example, whether the data are a speed, a temperature or an oscillation or a power and how the data are structured or what the data mean. Furthermore, the contents of the data cannot be interpreted by the database 4 either.

The monitoring system also includes first server software 15 which runs on a computation unit 14, second server software 18 which runs on a computation unit 17 and third server software 20 which runs on a computation unit 19. The computation units 14, 17 and 19 and, in particular, the respective server software 15, 18 and 20 associated with the computation units are connected to the Internet 9 in order to transmit data, which is illustrated by arrows 13, 16 and 21 in FIG. 1. In this case, the computation unit 14 is operated by the manufacturer X of the measuring devices X1 and X2 and is located at said manufacturer's premises within the scope of the exemplary embodiment. Within the scope of the exemplary embodiment, the computation unit 17 is operated by the manufacturer Y of the measuring device Y1 and is located at said manufacturer's premises. The computation unit 19 is operated by the manufacturer Z of the measuring device Z1 and is located at the premises belonging to the manufacturer Z. In this case, the computation units may each have only one central processor in the simplest case or else may be in the form of a multiprocessor system. However, the computation units may furthermore also consist of a plurality of individual computers, for example, which are networked to one another via a LAN connection, for example.

In this case, the first server software 15 knows how to interpret the first data X1′ and the fourth data X2′ and transforms the first data X1′ into first display data which can be interpreted by the web server software 2 and transforms the fourth data X2′ into fourth display data which can be interpreted by the web server software 2. The second server software 18 knows how to interpret the second data Y1′ and transforms the second data Y1′ into second display data which can be interpreted by the web server software 2. The third server software 20 knows how to interpret the third data Z1′ and transforms the third data Z1′ into third display data which can be interpreted by the web server software 2.

A user monitoring the state of the technical installation 5 can monitor the technical installation 5 using a computer 10 which is located at his premises and may be in the form of a personal computer, for example. The computer 10 has a web browser 11 running on it. The computer 10 and, in particular, the web browser 11 are connected in this case to the Internet 9 in order to transmit data, which is illustrated by an arrow 12 in FIG. 1. He can monitor the state of the technical installation 5 and can operate the monitoring system by calling up web pages which are constructed by the web server software 2.

It is noted at this point that the first, second and/or third server software 15, 18 and 20 can, however, alternatively also run on the computation device 1 and can be made available, for example, to the operator of the computation device 1 by the manufacturers of the measuring devices in the technical installation 5.

However, it goes without saying that hybrids are also conceivable in which the first server software 15, for example, runs on the computation unit 14 arranged at the premises belonging to the manufacturer X and the second server software 18 runs on the computation device 1 and is thus integrated in the computation device 1.

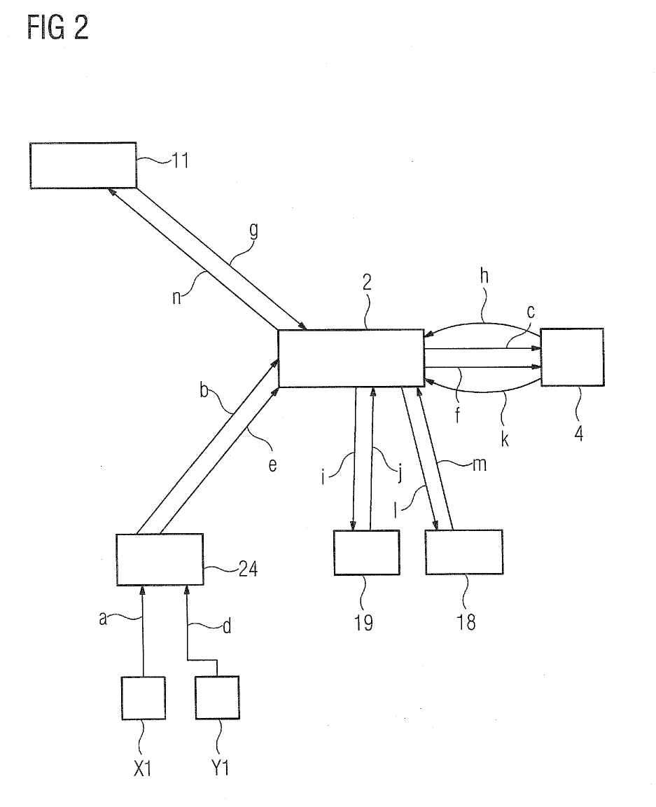

FIG. 2 illustrates a schematic block illustration of the sequence of the method according to the invention using the measuring device X1 and the first data X1′ generated by the latter and using the measuring device Y1 and the second data Y1′ generated by the latter. In this case, the same elements in FIG. 2 are provided with the same reference symbols as in FIG. 1. The method according to the invention takes place in a similar manner for the measuring device Z1 and the data Z1′ generated by the latter and for the measuring device X2 and the data X2′ generated by the latter.

The measuring device X1 from the manufacturer X generates the first data X1′ and transmits the latter, in a step a, to the client software 24 which runs on the computer 30 (see FIG. 1). It is noted in this case that the client software can also run on the respective measuring device and can thus be part of the respective measuring device. The computer 30 can then be dispensed with. In a step b, the first data X1′ are then transmitted from the client software 24 to the web server software 2 via the Internet 9 and are stored in the database 4 in a step c.

The measuring device Y1 from the manufacturer Y generates the second data Y1′ and transmits the latter to the client software 24 in a step d. In a step e, the second data Y1′ are then transmitted from the client software 24 to the web server software 2 via the Internet 9 and are stored in the database 4 in a step f.

Steps a, b, c, d, e and f are preferably carried out continuously or at particular intervals of time, with the result that current data from the measuring devices in the technical installation 5 are generally always stored in the database 4.

In a step g, a user uses the web browser 11 to transmit a request to display a web page, on which the first data X1′ and the second data Y1′ relating to the installation 5 are intended to be displayed on the computer 10, to the web server software 2 via the Internet 9. In said exemplary embodiment according to FIG. 2, a request to display the data relating to the first subsystem 6 of the installation 5 (see FIG. 1) is thus made.

The web server software 2 has access to the first data X1′ and second data Y1′ stored in the database 4.

In a step h, the first data X1′ are then transmitted from the database 4 to the web server software 2. In a subsequent step i, the first data X1′ are transmitted to the first server software 15. In this case, the first data X1′ are transmitted from the web server software 2 to the first server software 15, preferably in the form of an XML code (Extensible Markup Language). The first server software 15 transforms the first data X1′ into first display data which can be interpreted by the web server software 2. The first server software 15 which was preferably created by the manufacturer X of the measuring device X1, for example, knows how to interpret the first data X1′, that is to say knows that the first data X1′, for example, are speed values and/or that the unit of the first data is 1/sec. Furthermore, the server software 15 knows, for example, a specific data format which is possibly used and in which the measuring device X1 generated the first data X1′ and transmitted the latter to the client software 24. With the aid of this knowledge, that is to say how the first data X1′ should be interpreted, the first server software 15 transforms the first data X1′ into first display data which can be interpreted by the web server software 2 by transforming the first data X1′ into an HTML code (Hypertext Markup Language) within the scope of the exemplary embodiment. In a step j, the display data are then transmitted from the first server software 15 to the web server software 2. As already stated, the first display data are preferably in the form of an HTML code in this case and are transmitted from the server software 15 to the web server software 2 as an HTML code. In this case, the HTML code can be integrated, as a data packet, in an XML code used for transmission from the first server software 15 to the web server software 2.

In a step k, the second data Y1′ are then transmitted from the database 4 to the web server software 2. In a subsequent step I, the second data Y1′ are transmitted to the second server software 18. In this case, the second data Y1′ are transmitted from the web server software 2 to the second server software 18, preferably in the form of an XML code. The second server software 18 transforms the second data Y1′ into second display data which can be interpreted by the web server software 2. The second server software 18 which was preferably created by the manufacturer Y of the measuring device Y1, for example, knows how to interpret the second data Y1′, that is to say knows that the second data Y1′, for example, are oscillation values and/or that the unit of the second data is 1/sec. Furthermore, the server software 18 knows, for example, a specific data format which is possibly used and in which the measuring device Y1 generated the second data Y1′ and transmitted the latter to the client software 24. With the aid of this knowledge, that is to say how the second data Y1′ should be interpreted, the second server software 18 transforms the second data Y1′ into second display data which can be interpreted by the web server software 2 by transforming the second data Y1′ into an HTML code (Hypertext Markup Language) within the scope of the exemplary embodiment. In a step m, the display data are then transmitted from the second server software 18 to the web server software 2. As already stated, the second display data are preferably in the form of an HTML code in this case and are transmitted from the server software 18 to the web server software 2 as an HTML code. In this case, the HTML code can be integrated, as a data packet, in an XML code used for transmission from the second server software 18 to the web server software 2.

The web server software 2 then uses the first and second display data to construct the web page requested by the user and transmits the latter to the web browser 11 in a step g in order to display the web page on the computer 10. In this case, in addition to the pure display of the display data, the web page may also contain virtual operating elements which can be used by the user to operate the monitoring system, for example by a corresponding mouse click on the corresponding operating element displayed on the screen of the computer 10. The web page is thus preferably part of a user interface on which the data provided by the measuring devices in the installation 5 are displayed and on which the monitoring system can also be operated, if appropriate.

It goes without saying that a plurality of computers 10 with corresponding web browsers 11 may also be present in this case and a plurality of users who are intended to monitor the technical installation 5 may thus access the data from the measuring devices in the technical installation 5 and may have the data displayed. However, it goes without saying that only the data from an individual measuring device may also be displayed to the user.

It goes without saying that the technical installation 5 may also include, for example, a plurality of wind turbines or an individual wind turbine park or a plurality of wind turbine parks each having a plurality of wind turbines.

It is also noted that the term “measuring device” should be understood in a broader sense within the scope of the invention. Within the scope of the exemplary embodiment, the first, second, third and fourth data were in the form of measurement data, for example a measured speed. This need not necessarily be the case. In this case, the first, second, third or fourth data may also be in the form of data processed inside the measuring device, for example. A mean value can thus be calculated from the measured data inside the measuring device, for example, and only the mean value can be transmitted to the client software 24, for example as first data. Furthermore, the measuring devices may also be designed to measure a plurality of different measurement variables (for example temperature and power).

Furthermore, the first, second, third and/or fourth data, for example, may be derived from an individual item of measured measurement data or from a plurality of items of measured measurement data (for example speed, oscillation, temperature, power etc.) and may be transmitted on their own or in addition to the measurement data to the client software 24 as data and may be displayed on the computer 10 in accordance with the method according to the invention.

The invention makes it possible to easily integrate the measuring devices from different manufacturers in a monitoring system and to display the data respectively generated by said devices for the user. Furthermore, retrofitted measuring devices may also be subsequently integrated in the monitoring system in a simple manner even in the case of an existing technical installation, in which case, in particular, the computation device 1 and the web server software 2 running on the latter and the database software do not have to be adapted or have to be only very slightly adapted.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for monitoring a state of a technical installation, comprising the steps of:
transmitting, by using a web browser, via the Internet to web server software a user request to display a web page with first data relating to the technical installation, wherein the web server software has access to the first data,
transmitting with the web server software the first data to first server software,
transforming with the first server software the first data into first display data configured to be interpreted by the web server software,
transmitting the first display data to the web server software for construction of the web page with the first data, and
transmitting the constructed web page to the web browser for displaying the web page.

2. The method of claim 1, further comprising the steps of:
transmitting second data in addition to the first data, wherein the web server software has access to the first and second data,
transmitting with the web server software the second data to second server software,
transforming with the second server software the second data into second display data configured to be interpreted by the web server software,
transmitting the second display data to the web server software for construction of the web page with the first and second data, and
transmitting the web page constructed with the first and second data to the web browser for displaying the web page.

3. The method of claim 1, wherein the first data are transmitted to the server software via the Internet, and wherein the first display data are transmitted from the server software to the web server software via the Internet.

4. The method of claim 1, wherein the second data are transmitted to the server software via the Internet, and wherein the second display data are transmitted from the server software to the web server software via the Internet.

5. The method of claim 1, wherein the data are transmitted from the web server software to the server software in the form of XML code.

6. The method of claim 1, wherein the display data are in the form of HTML code.

7. The method of claim 1, wherein the web page is transmitted to the web browser in form of HTML code.

8. The method of claim 1, further comprising the steps of:
generating the first data with at least one measuring device disposed on the technical installation,
transmitting the first data from the installation, via the Internet, to a computation device on which the web server software runs, and
storing the transmitted first data in the computation device.

9. The method of claim 2, further comprising the steps of:
generating the second data with at least one measuring device disposed on the technical installation,
transmitting the second data from the installation, via the Internet, to a computation device on which the web server software runs, and
storing the transmitted second data in the computation device.

10. The method of claim 1, wherein the technical installation is constructed as a wind power system.

11. A monitoring system for monitoring a state of a technical installation, the monitoring system comprising:
a computation device storing first data relating to the technical installation,
web server software running on the computation device and causing the computation device to:
transmit, by using a web browser, via the Internet to web server software a user request to display a web page with the first data relating to the technical installation, wherein the web server software has access to the first data,
transmit with the web server software the first data to first server software,
transform with the first server software the first data into first display data configured to be interpreted by the web server software,
transmit the first display data to the web server software for construction of the web page with the first data, and
transmit the constructed web page to the web browser for displaying the web page.

12. The monitoring system of claim 11, wherein the first server software runs on a first computation unit different from the computation device, and wherein the first computation unit is connected to the computation device via the Internet.

13. The monitoring system of claim 11, wherein the first server software runs on the computation device.
